(19) United States
(12) Patent Application Publication
(10) Pub. No.: US 2011/0223362 A1
(43) Pub. Date: Sep. 15, 2011

(54) METALIZED IN MOLD LABEL AND MOLDED ARTICLES HAVING SAME

(76) Inventors: Jonathan Van Loon, Hastings, MN (US); John Tomczyk, Shoreview, MN (US)

(21) Appl. No.: 13/043,796

(22) Filed: Mar. 9, 2011

Related U.S. Application Data
(60) Provisional application No. 61/311,938, filed on Mar. 9, 2010.

(51) Int. Cl. G09F 3/00; B44C 1/14; B32B 15/00

(52) U.S. Cl. 428/34.1; 156/233; 428/203

(57) ABSTRACT

A printed metalized in mold label (IML) or insert for use in manufacturing injection molded or blow molded drinkware or containers. The labels generally include a metalized film assembly that comprises a base substrate and a metalized layer applied thereon. One or more image or graphic layers are then either printed directly onto the metalized film assembly or laminated thereto. Protective substrates, films, or coatings are applied to the assembly to protect by sandwiching the one or more ink or printed layers between the protective layer and the metalized layer.

### RELATED APPLICATION

This application claims the benefit of U.S. Provisional Application Ser. No. 61/311,938 filed Mar. 9, 2010, and entitled “METALIZED IN MOLD LABEL AND MOLDED ARTICLES HAVING SAME,” which is hereby incorporated by reference in its entirety.

### FIELD OF THE INVENTION

The invention relates generally to in mold labels, and more particularly to metalized in-mold labels for use molding processes for the manufacturer of articles.

### BACKGROUND OF THE INVENTION

Molded articles having metalized labels have become popular in recent years. A variety of molded articles, such as cups, containers, packaging, card, and the like include a label or other insert having a metalized surface to create unique eye-catching features and graphics. For example, the label can include a mirror-like finish along with printed graphics and text.

However, there are many problems associated with manufacturing a molded article having metalized labels. Typically, a static or electrostatic mechanism is used to hold the label in place within the tool or molding die. Because of the metalized or foiled portion of the label, an undesired electric arc is formed in the static hold in the mold, which can thereby shut down or have other detrimental effects on the electric power to the static hold. The label is then free to move around or fall out of the mold during molding, which results in a defective article.

Approaches have been taken to overcome this issue. For example, a frame system can be used that includes providing a plastic frame around a metalized label to keep the foiled edge away from the static hold. However, this adds manufacturing steps to the production of the label and can be both time consuming and expensive.

There remains a need for a metalized in mold label that can be economically and efficiently produced, and that provides sufficient structural integrity to be used within molds without the need for an electrostatic hold.

### SUMMARY OF THE INVENTION

A printed metalized in mold label (IML) or insert according to embodiments of the present invention overcome many of the deficiencies described above. The labels or inserts can be used in molding processes, such as those used in injection molding or blow molding, and are held in place within the molds by mechanical means, such as by vacuum, eliminating the need for a static hold. The labels of the present invention have sufficient spring back or structural integrity such that it is held in place during molding processes, eliminating or reducing the occurrence of the label folding in on itself.

The labels according to embodiments of the invention generally include a metalized film assembly that comprises a base substrate and a metalized layer applied thereon. One or more image or graphic layers are then either printed directly onto the metalized film assembly or laminated thereto. Protective substrates, films, or coatings are applied to the assembly to protect by sandwiching the one or more ink or printed layers between the protective layer and the metalized layer.

In one embodiment of the invention, a metalized substrate assembly is laminated or combined with a printed protective substrate by an adhesive layer sandwiched there between. In another embodiment of the invention, a protective coating is applied over one or more ink layers printed directly on the metalized layer of the metalized substrate assembly. In yet another embodiment of the invention, a protective film is laminated over one or more ink layers printed directly on the metalized layer of the metalized substrate assembly.

The labels or inserts can be formed individually, in sheet form, or in web form. If in sheet or web form, the labels are then converted after assembly of the different layers, thereby forming the printed metalized in mold label. The label is then used in injection or blow molding processes to form articles, such as cups, containers, and packaging, having an integral printed metalized in mold label. In an alternative embodiment, the sheet or label is formed into its own self-supporting container.

The resulting container or cup with integral label provides sufficient structural integrity such that it is dish-washer safe, and can be used multiple times without delamination. The printed metalized in mold label can be efficiently and economically produced, while offering eye-catching features on the surface of the article or container.

The above summary of the invention is not intended to describe each illustrated embodiment or every implementation of the present invention. The detailed description that follows more particularly exemplifies these embodiments.

### BRIEF DESCRIPTION OF THE DRAWINGS

FIG. 1 is a cross-section view of a metalized in mold label according to an embodiment of the invention;

FIG. 2 is a cross-section view of a surface printed metalized in mold label according to another embodiment of the invention; and

FIG. 3 is a cross-section view of a protected surface printed metalized in mold label according to another embodiment of the invention.

While the invention is amenable to various modifications and alternative forms, specifics thereof have by shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the claims.

### DETAILED DESCRIPTION OF THE DRAWINGS

As described above, printed metalized in mold labels (IML) according to embodiments of the present invention generally include a metalized film assembly that comprises a base substrate and a metalized layer applied thereon. One or more image or graphic layers are then either printed directly onto the metalized film assembly or laminated thereto. Protective substrates, films, or coatings are applied to the assembly to protect by sandwiching the one or more ink or printed layers between the protective layer and the metalized layer, as described in detail in the embodiments below.

### Protected Ink Construction

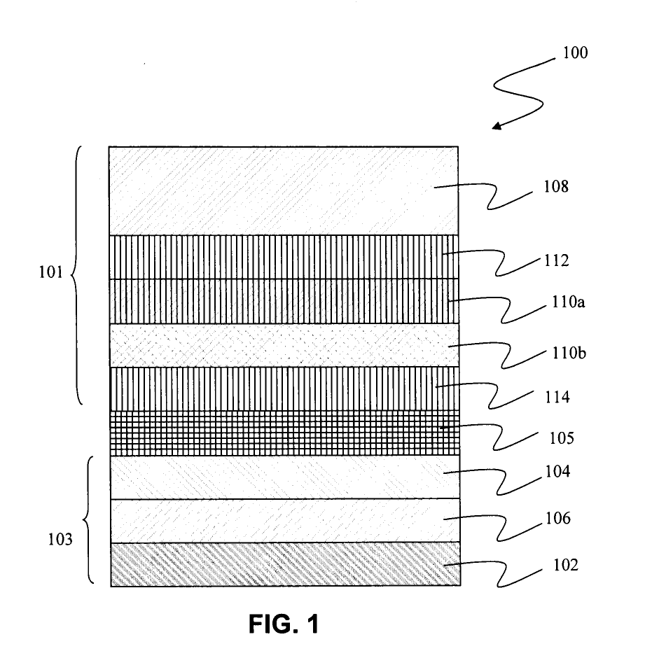

In one embodiment of the invention, referring to FIG. 1, a protected ink construction sheet 100 for use as printed metalized in mold labels (IML) comprises a protective substrate assembly 101 combined with a metalized substrate assembly 103. Printed protective substrate assembly 101 can be laminated or otherwise bonded to metalized substrate assembly 103 by an adhesive layer 105, such as, for example, a 2-part urethane adhesive. For exemplary purposes only, the construction is in sheet form for converting a plurality of labels therefrom; however, other forms are contemplated. For example, sheet 100 can be its own individual label.

Metalized substrate assembly 103 can generally include a base substrate 102 and a metalized layer 104 over at least a portion of base substrate 102. Base substrate 102 can comprise a polymeric film made up of one or more virgin and/or recycled polymers, such as, for example, a polypropylene film, polyethylene film. Base substrate 102 can be from about 1 to about 10 mils thick. Base substrate 102 can be transparent, translucent, or opaque. One or both surfaces can be gloss or matte finish, or combinations thereof. In one particular embodiment, base substrate 102 comprises a polypropylene film, such as, for example, a 2-2.3 mil oriented polypropylene film, such as EWR-50 or EWR-57 Treofan available from The Treofan Group of Raunheim, Germany, or others such as AET Films 313-125 of New Castle, Del., Innovia Film WPA230, RayoForm IW58 available from Innovia Films, and Yupo XFS80 available from Yupo Synthetic Paper.

Base substrate 102 is then metalized over at least a portion of a first surface of base substrate 102 to form metalized substrate assembly 103. The metalizing process can include application of a metalized layer 104 having an e-beam adhesive 106 to base substrate 102. Metalized layer 104 can be foil layers available from Transilwrap Company, Inc. of Strongsville, Ohio, Unifoil of Fairfield, N.J., and Protect-All available from PFFC of Chicago, Ill. The assembly of the metalized layer 104, e-beam adhesive 106, and base substrate 102 is then subjected to e-beam radiation, such as, for example, gamma radiation, for a period of time sufficient to activate e-beam adhesive 106, thereby bonding metalized layer 104 to base substrate 102. Examples of metallization processes can be found in U.S. Patent Application Publication Nos. 2008/0213551 A1, 2008/0187770 A1, and 2005/0196604 A1, all entitled “Metallization process and product produced thereby” and all incorporated by reference herein in their entireties.

In one particular embodiment of the invention for metalizing the substrate, base substrate 102 is metalized using a transfer film that comprises a carrier film and a metal layer or metal-containing layer with a breakaway coating positioned therebetween. The process of creating this transfer film begins by providing a carrier film comprising a thin flexible sheet or film of material such as, for example, acetate; cellophane; polypropylene; polyethylene; polyester; polystyrene; holographic or diffraction films; clear, dyed, filled or coated films; mat finished films; metallized, full or patterned films; microwave and susceptor film; and treated film such as corona or chemically treated film, and the like.

An uncured breakaway coating or adhesive is applied to the film using processes such as UV offset printing, conventional offset printing, gravure and flexo printing, offset gravure, silk screen printing, air knife, metering rod, and roll coating, according to methods generally known in the industry. The breakaway coating can comprise, for example, acrylates; urethane acrylates; epoxy acrylates; polyester acrylates; acrylate acrylics and other oligomers and polymers having suitable properties as a release or breakaway coating. The breakaway coating can comprise single layer or several layers, either of the same material or of different materials working together to form a single, or integrated, coating layer, such as a mixture, or multiple layers applied sequentially. The breakaway coating is then cured according to methods known in the art, including oven drying and chemical crosslinking, using, e.g., infrared heating, high and low velocity heated air, etc. Alternatively, and where the coating is susceptible to radiation curing as a consequence of its chemical composition, it can be cured using an EB curing process using equipment and conditions known in the art for such processes.

A metal or metal-containing layer, typically in the form of a foil, is then deposited onto the cured breakaway coating by conventional methods such as vapor deposition or vacuum metallization to form a layer having a thickness from about 20 angstroms to about 1000 angstroms. The term “metal” is defined in the usual manner as any of various opaque, fusible, ductile and typically lustrous substances that are good conductors of electricity and heat. The metal layer of the present invention includes at least one metal, such as, for example, aluminum, silver, gold, platinum, zinc, copper, nickel, tin, silicon, and alloys and mixtures thereof. Deposition of the metal layer is accomplished by methods well-known in the art, including, e.g., vacuum deposition, sputtering, etc.

The metalized transfer film is a relatively stable product at this point, and can be rolled into large diameter rolls for future use or used immediately. If desired, the transfer film can be created in one facility, and transferred to a second facility or second location within the same facility to continue with the remainder of the process according to embodiments of the invention.

Base substrate 102 is then coated with a transfer adhesive. The transfer adhesive can comprise at least one component selected from the group comprising urethane acrylate resin; epoxy acrylate resin; polyester acrylate resin; mono- di-, tri-, or tetra-hexacrylate resin; and mixtures thereof. In one particular embodiment of the invention, the transfer adhesive comprises a urethane acrylate resin that is radiation curable, and preferably using electron beam (EB) radiation. The transfer adhesive can further include at least one additive selected from the group consisting of fillers, dyes and pigments. Such additives can find utility for modifying the processing or final properties of the adhesive composition and its performance in the layered structure. The transfer adhesive can be applied to the substrate utilizing the techniques previously listed with respect to the breakaway coating, such as digital inkjet, drop on demand, gravure and flexo printing, and can be done selectively, so as to create a decorative surface with one or more predetermined, e.g., discontinuous areas, such as a pattern, or in a continuous manner.

Following application of the transfer adhesive, the transfer film is placed in contact with the substrate/transfer adhesive element or assembly, with the metal of the transfer film adjacent the transfer adhesive to form an intermediate product having a structure comprising substrate/transfer adhesive/metal/breakaway coating/film. The “transfer film” is then secured to the substrate by means of the transfer adhesive, and optionally with the application of pressure. The intermediate product is then exposed to radiation curing, e.g., by being placed in or passed through an EB curing device, to rapidly cure the transfer adhesive. The film is then removed from the intermediate product such that the metal is bonded to the transfer adhesive. At least some of the breakaway adhesive can be present as well. In an alternative embodiment of the invention, the breakaway coating is substantially or completely removed with the transfer film such that the metal layer is substantially free of the breakaway coating material.

In areas where the transfer adhesive is applied, the metal adheres to the substrate, and is from the transfer film. In the void areas of the substrate, the breakaway coating and metal remain adhered to the transfer film and do not bond to the substrate, and are either discarded therewith or reused in a subsequent process. In such a structure, the breakaway coating, metalized area and selectively applied adhesive are in substantial registration; i.e., aligned with one another so as to produce one or more sharp or precise edges. Alternatively, substantially the entire surface of the substrate 102 can be coated with the transfer adhesive such that it will be metalized in its entirety, rather than selectively, if so desired. If the entire surface is coated, there will be no void areas.

Either inline or in a separate process from the metallization process, printed protective assembly 101 can be assembled or manufactured. Printed protective assembly 101 generally includes a protective substrate or covering layer 108 having one or more graphic layers 110 printed or otherwise applied thereon. Printed protective assembly 101 can further include one or more optional coatings or treatment layers as discussed in further detail below.

Protective substrate 108, such as one or more layers of polypropylene, polyester, APET, polystyrene, or any other variety of polymer layers or combinations thereof, is printed using a four color process (4-CP) separation, a white spot printing process, for example, no more than 25% spot white, or other printing technique with desired graphics, text, or other indicia to form one or more graphic layers 110. Protective substrate 108 can comprise one or more virgin and/or recycled polymers, such as, for example, APET, polypropylene, polyethylene, polystyrene, and combinations thereof. Protective substrate 108 can be transparent or clear such that one or more graphic layers 110 are viewable therethrough. One or both surfaces can be gloss or matte finish, or combinations thereof. Protective substrate 108 can include additional treatments such as anti-block additives, corona or flame treatment, and other treatments depending on the desired properties of the film. Protective substrate 108 can comprise a thickness from about 1 to about 20 mils. In one particular embodiment, protective substrate 108 comprises a clear APET material with anti-block, the material having a gloss finish on both sides, and having a thickness of about 12 to about 14 mils. In another particular embodiment, protective substrate 108 is substantially free from a polyethylene material. In yet another embodiment, all layers of the in-mold label are substantially free from polyethylene.

In one particular embodiment of the invention, the in-mold label is used to produce drinking cups or containers. Protective substrate 108 is in direct contact with the liquid or other food material, to be imbibed and/or the user's mouth, tongue or lips. Therefore, protective substrate 108 preferably comprises a food-safe material or coating thereon.

Protective substrate 108 can optionally include additional coatings or layers applied thereon. Such coatings can include, for example, a primer layer 112 for increasing ink adhesion. Suitable primers can include Northwest LPX-3 Primer, available from Northwest Coatings, a part of Ashland, Inc., primers available from INX International Ink Co. of Schaumburg, Ill., and primers available from Henkel of Dusseldorf, Germany. Primer layer 112 can be applied to protective substrate 108 by any of a number of suitable coating techniques including, but not limited to, extruding, casting, printing such as inkjet printing, flexographic printing, rotogravure, curtain coating, spraying, gravure, mire rod coating, and the like. Primer layer 112 is then appropriately cured depending on its composition. For example, if a UV-curable primer is used, then it is exposed to UV radiation for a sufficient time to cure the primer.

One or more graphic layers 110 can be printed using any of a number of suitable printing techniques including, but not limited to, digital printing such as inkjet printing, flexographic printing, lithography, rotogravure, gravure, and the like. Graphic layer(s) 110 can be formed using any of a variety of suitable inks, such as, for example, UV-curable inks, toners, water- or solvent-based inks, solventless inks, other forms of radiation curable inks, and combinations thereof. In one embodiment, graphic layer 110 is formed from UV curable inks, such as SUNCURE inks commercially available from Sun Chemical of Carlstadt, N.J., Flint Inks of St. Paul, Minn., and/or Wikoff Color Corporation of Fort Mill, S.C.

In one particular embodiment, as illustrated in FIG. 1, graphic layer(s) 110 include a first ink layer 110a comprising a UV-curable ink four color process (4-CP) separation layer, followed by a second ink layer 110b comprising a white UV-curable ink layer, such as a white spot printed continuous or discontinuous layer, for example, no more than 25% printed white. First ink layer 110a is sufficiently cured upon exposure to UV radiation before second ink layer 110b is applied, which is then sufficiently cured upon exposure to UV radiation.

An optional coating layer 114 can then be applied over at least a portion of graphic layer(s) 110. Such coatings can include, for example, a primer layer similar to primer layer 112. Coating layer 114 can be applied by any of a number of suitable coating techniques including, but not limited to, extruding, casting, printing such as inkjet printing, flexographic printing, rotogravure, curtain coating, spraying, gravure, mire rod coating, and the like. Coating layer 114 is then appropriately cured depending on its composition. For example, if a UV-curable primer is used, then it is exposed to UV radiation for a sufficient time to cure the primer.

Printed protective assembly 101 is then laminated or otherwise bonded to metalized substrate assembly 103 to form protected ink construction sheet 100 by any of a variety of suitable techniques, such as by adhesive layer 105. Adhesive layer 105 can comprise, for example, any of a number of suitable adhesives including radiation curable adhesives, moisture cure adhesive, urethane adhesive, water-based or other solvent-based adhesive, and combinations thereof. In one particular embodiment, adhesive layer 105 comprises a two-part urethane adhesive, such as a polymeric laminating adhesive, available from Polymeric Imaging Inc. of North Kansas City, Mo. Other suitable adhesives are available from Ashland, Inc. of Covington, Ky., HB Fuller Co. of St. Paul, Minn., and Henkel of Dusseldorf, Germany.

Adhesive layer 105 can be applied to the inner most layer or surface of one or both of printed protective assembly 101 or metalized substrate assembly 103. Adhesive layer 105 can be applied by any of a number of techniques including, but not limited to extruding, casting, printing such as inkjet printing, flexographic printing, rotogravure, curtain coating, spraying, gravure, mire rod coating, and the like. Heat and/or pressure is then applied to combine or bond printed protective assembly 101 with metalized substrate assembly 103.

Upon sufficient curing of adhesive layer 105, protected ink construction sheet 100 is then converted, such as by die cutting, into the appropriate label size for use in injection molding or blow molding techniques for manufacturing labeled plastic products. For example in injection molding, the in-mold label is placed into the female wall of a mold such that protective substrate 108 is proximate the wall of the mold. The label is held by mechanical means, such as by vacuum, or held in with friction. A plastic charge or molten material is then introduced into the mold and bonds to the inner most layer, i.e. base substrate 102 to form the final molded product with integral metalized label, such as a drinking cup. The plastic charge material can comprise any of a variety of plastic materials including, but not limited to, polypropylene, polycarbonate, high density polyethylene, and combinations thereof. Upon cooling, the product is ejected from the mold. One such suitable in-mold labeling technique is described in detail in U.S. Pat. No. 7,153,555 to Raymond et al., which is incorporated herein by reference in its entirety.

In one particular embodiment of the invention, the inmold label is used to produce drinking cups or containers. The plastic charge material, i.e. the molded plastic material, is in direct contact with the liquid or other food material to be imbibed. Therefore, the charge material preferably comprises an FDA approved, or food-safe material for direct food contact. Base substrate 102 can optionally comprise a food-safe material or coating thereon for indirect food contact.

Surface Printed Metalized Label with Coating Composition

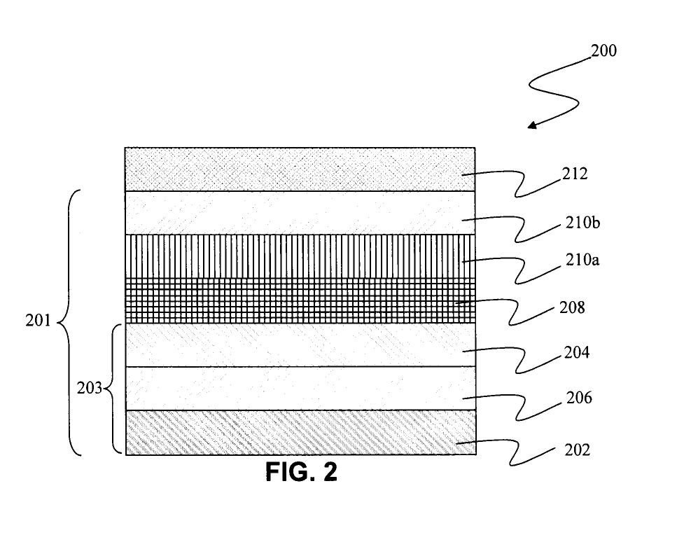

In a second embodiment of the invention, illustrated in FIG. 2, a coating construction sheet 200 for use as a surface printed metalized in mold label (IML) comprises a protective coating layer 212 covering a printed metalized substrate assembly 201. For exemplary purposes only, the construction is in sheet form for converting a plurality of labels therefrom; however, other forms are contemplated. For example, sheet 100 can be its own individual label.

A metalized substrate assembly 203 is formed similar to metalized substrate assembly 103 described in the first embodiment and can generally include a base substrate 202 and a metalized layer 204 over at least a portion of base substrate 202. Base substrate 202 can comprise a polymeric film made up of one or more virgin and/or recycled polymers, such as, for example, a polypropylene film, polyethylene film. Base substrate 202 can be from about 1 to about 20 mils thick, and more particularly from about 5 to about 10 mils thick. Base substrate 202 can be transparent, translucent, or opaque. One or both surfaces can be gloss or matte finish, or combinations thereof. In one particular embodiment, base substrate 202 comprises a polypropylene film such as, for example, a 7-10 mil polypropylene film, such as Trans TR available from Transilwrap Company, Inc. of Strongsville, Ohio, AET Films 313-125 of New Castle, Del., Innovia Film WPA230, RayoForm IW58 available from Innovia Films, and Yupo XFS80 available from Yupo Synthetic Paper.

Base substrate 202 is then metalized over at least a portion of a first surface of base substrate 202 to form metalized substrate assembly 203. The metalizing process can include application of a metalized layer 204 having an e-beam adhesive 206 to base substrate 202 as described above and detailed in U.S. Application Publication Nos. 2008/0213551 A1, 2008/0187770 A1, and 2005/0196604 A1. Metalized layer 204 can be foil layers available from Transilwrap Company, Inc. of Strongsville, Ohio, Unifoil of Fairfield, N.J., and Protect-All available from PFFC of Chicago, Ill. The assembly of the metalized layer 204, e-beam adhesive 206, and base substrate 202 is then subjected to e-beam radiation, such as, for example, gamma radiation, for a period of time sufficient to activate e-beam adhesive 206, thereby bonding metalized layer 204 to base substrate 202.

A primer layer 208 is optionally applied to at least a portion of metalized layer 204, for increasing ink adhesion. Suitable primers can include Northwest LPX-3 Primer, available from Northwest Coatings, a part of Ashland, Inc., primers available from INX International Ink Co. of Schaumburg, Ill., and primers available from Henkel of Dusseldorf, Germany. Primer layer 208 can be applied by any of a number of suitable coating techniques including, but not limited to, extruding, casting, printing such as inkjet printing, flexographic printing, rotogravure, curtain coating, spraying, gravure, mire rod coating, and the like. Primer layer 208 is then appropriately cured depending on its composition. For example, if a UV-curable primer is used, then it is exposed to UV radiation for a sufficient time to cure the primer.

One or more graphic layers 210 can be printed on at least a portion of optional primer layer 208 if present or directly on at least a portion of metalized layer 204 using any of a number of suitable printing techniques including, but not limited to, digital printing such as inkjet printing, flexographic printing, lithography, rotogravure, gravure, and the like. Graphic layer(s) 210 can be formed using any of a variety of suitable inks, such as, for example, UV-curable inks, toners, water- or solvent-based inks, solventless inks, other forms of radiation curable inks, and combinations thereof. In one embodiment, graphic layer 210 is formed from UV curable inks, such as SUNCURE inks commercially available from Sun Chemical of Carlstadt, N.J., Flint Inks of St. Paul, Minn., and/or Wikoff Color Corporation of Fort Mill, S.C.

In one particular embodiment, as illustrated in FIG. 2, graphic layer(s) 210 include a first ink layer 210a comprising a white UV-curable ink layer, followed by a second ink layer 210b comprising UV-curable ink four color process (4-CP) separation layer, as described in the first embodiment. First ink layer 210a is sufficiently cured upon exposure to UV radiation before second ink layer 210b is applied, which is then sufficiently cured upon exposure to UV radiation.

A protective coating layer 212 is then applied over graphic layer(s) 210. Protective coating layer 212 can be transparent or clear such that one or more graphic layers 210 are viewable therethrough. Suitable clear coatings can include UV-curable or other radiation curable coatings, moisture cure coatings, urethane coatings, and combinations thereof. In one particular embodiment, protective coating layer 212 comprises an acrylate ester clear coating, available from Polymeric Imaging Inc. of North Kansas City, Mo. It is a form of clear UV-curable ink. Other suitable coatings are available from INX International Ink Co. of Schaumburg, Ill., and Henkel of Dusseldorf, Germany. In a particular embodiment, protective coating layer 212 is substantially free from a polyethylene material. In yet another embodiment, all layers of the in-mold label are substantially free from polyethylene.

In one particular embodiment of the invention, the inmold label is used to produce drinking cups or containers. Protective coating layer 212 is in direct contact with the liquid or other food material, to be imbibed and/or the user's mouth, tongue or lips. Therefore, protective coating layer 212 preferably comprises a food-safe material or coating thereon.

Protective coating layer 212 can be applied by any of a number of suitable coating techniques including, but not limited to, extruding, casting, printing such as inkjet printing, flexographic printing, rotogravure, curtain coating, spraying, gravure, mire rod coating, and the like. Protective coating layer 212 is then appropriately cured depending on its composition. For example, if a UV-curable primer is used, then it is exposed to UV radiation for a sufficient time to cure the primer.

Upon sufficient curing of protective coating layer 212, coating construction sheet 200 is then converted, such as by die cutting, into the appropriate label size for use in injection molding or blow molding techniques for manufacturing labeled plastic products. For example in injection molding, the in-mold label is placed into the female wall of a mold such that protective coating layer 212 is proximate the wall of the mold. The label is held by mechanical means, such as by vacuum or friction. A plastic charge or molten material is then introduced into the mold and bonds to the inner most layer, i.e. base substrate 202 to form the final molded product with integral metalized label, such as a drinking cup. The plastic charge material can comprise any of a variety of plastic materials including, but not limited to, polypropylene, polycarbonate, high density polyethylene, and combinations thereof. Upon cooling, the product is ejected from the mold. One such suitable in-mold labeling technique is described in detail in U.S. Pat. No. 7,153,555 to Raymond et al., which is incorporated herein by reference in its entirety.

In one particular embodiment of the invention, the inmold label is used to produce drinking cups or containers. The plastic charge material, i.e. the molded plastic material, is in direct contact with the liquid or other food material to be imbibed. Therefore, the charge material preferably comprises an FDA approved, or food-safe material for direct food contact. Base substrate 202 can optionally comprise a food-safe material or coating thereon for indirect food contact.

Protected Surface Printed Metalized Label with Polypropylene Film Construction

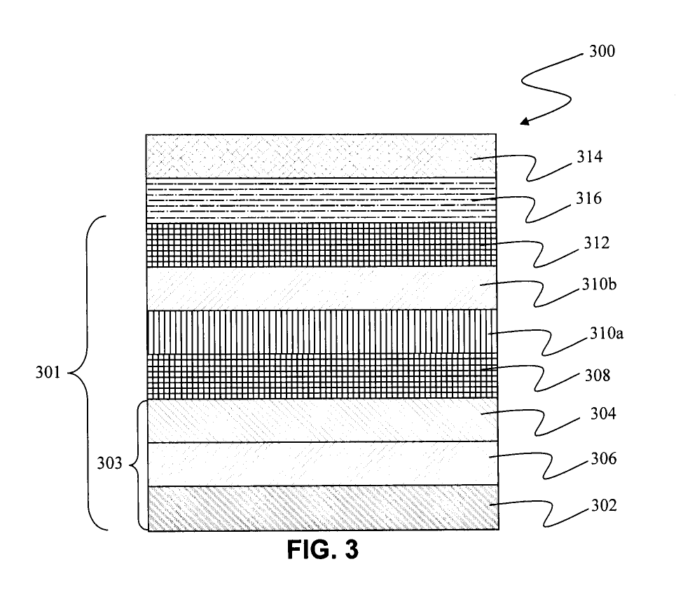

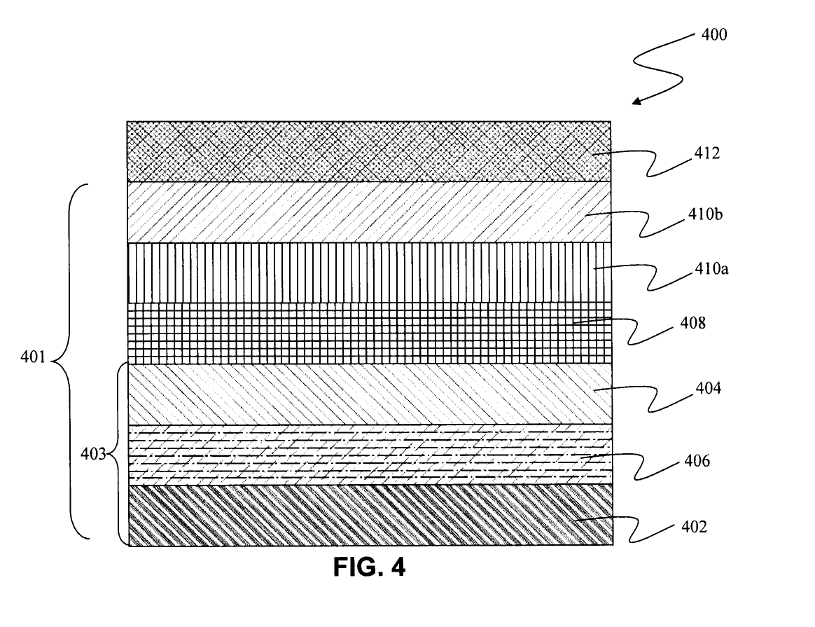

In a third embodiment of the invention, illustrated in FIG. 3, a laminated film construction sheet 300 for use as a surface printed metalized in mold label (IML) comprises a protective film 314 covering a printed metalized substrate assembly 301. For exemplary purposes only, the construction is in sheet form for converting a plurality of labels therefrom; however, other forms are contemplated. For example, sheet 300 can be its own individual label.

A metalized substrate assembly 303 is formed similar to metalized substrate assembly 103, 203 described in the first and second embodiments and can generally include a base substrate 302 and a metalized layer 304 over at least a portion of base substrate 302. Base substrate 302 can comprise a polymeric film made up of one or more virgin and/or recycled polymers, such as, for example, a polypropylene film, polyethylene film. Base substrate 302 can be from about 1 to about 20 mils thick, and more particularly from about 5 to about 10 mils thick. Base substrate 302 can be transparent, translucent, or opaque. One or both surfaces can be gloss or matte finish, or combinations thereof. In one particular embodiment, base substrate 302 comprises a polypropylene film such as, for example, a 7-10 mil polypropylene film, such as Trans TR available from Transilwrap Company, Inc. of Strongsville, Ohio, or others such as AET Films 313-125 of New Castle, Del., Innovia Film WPA230, RayoForm IW58 available from Innovia Films, and Yupo XFS80 available from Yupo Synthetic Paper.

Base substrate 302 is then metalized over at least a portion of a first surface of base substrate 302 to form metalized substrate assembly 303. The metalizing process can include application of a metalized layer 304 having an e-beam adhesive 306 to base substrate 302 as described above and detailed in U.S. Application Publication Nos. 2008/0213551 A1, 2008/0187770 A1, and 2005/0196604 A1. Metalized layer 304 can be foil layers available from Transilwrap Company, Inc. of Strongsville, Ohio, Unifoil of Fairfield, N.J., and Protect-All available from PFFC of Chicago, Ill. The assembly of the metalized layer 304, e-beam adhesive 306, and base substrate 202 is then subjected to e-beam radiation, such as, for example, gamma radiation, for a period of time sufficient to activate e-beam adhesive 306, thereby bonding metalized layer 304 to base substrate 302.

A primer layer 308 is optionally applied to at least a portion of metalized layer 304, for increasing ink adhesion. Suitable primers can include Northwest LPX-3 Primer, available from Northwest Coatings, a part of Ashland, Inc., primers available from INX International Ink Co. of Schaumburg, Ill., and primers available from Henkel of Dusseldorf, Germany. Primer layer 308 can be applied by any of a number of suitable coating techniques including, but not limited to, extruding, casting, printing such as inkjet printing, flexographic printing, rotogravure, curtain coating, spraying, gravure, mire rod coating, and the like. Primer layer 308 is then appropriately cured depending on its composition. For example, if a UV-curable primer is used, then it is exposed to UV radiation for a sufficient time to cure the primer.

One or more graphic layers 310 can be printed on at least a portion of optional primer layer 308 if present or directly on at least a portion of metalized layer 304 using any of a number of suitable printing techniques including, but not limited to, digital printing such as inkjet printing, flexographic printing, lithography, rotogravure, gravure, and the like. Graphic layer(s) 310 can be formed using any of a variety of suitable inks, such as, for example, UV-curable inks, toners, water- or solvent-based inks, solventless inks, other forms of radiation curable inks, and combinations thereof. In one embodiment, graphic layer 310 is formed from UV curable inks, such as SUNCURE inks commercially available from Sun Chemical of Carlstadt, N.J., Flint Inks of St. Paul, Minn., and/or Wikoff Color Corporation of Fort Mill, S.C.

In one particular embodiment, as illustrated in FIG. 3, graphic layer(s) 310 include a first ink layer 310a comprising a white UV-curable ink layer, followed by a second ink layer 310b comprising UV-curable ink four color process (4-CP) separation layer, as described in the first embodiment. First ink layer 310a is sufficiently cured upon exposure to UV radiation before second ink layer 310b is applied, which is then sufficiently cured upon exposure to UV radiation.

A second optional primer layer 312 is applied to at least a portion of graphic layer(s) 310, for increasing compatibility between graphic layer 310 and subsequent layers. Suitable primers can include again Northwest LPX-3 Primer, available from Northwest Coatings, a part of Ashland, Inc., primers available from INX International Ink Co. of Schaumburg, Ill., and primers available from Henkel of Dusseldorf, Germany. Primer layer 312 can be applied by any of a number of suitable coating techniques including, but not limited to, extruding, casting, printing such as inkjet printing, flexographic printing, rotogravure, curtain coating, spraying, gravure, mire rod coating, and the like. Primer layer 308 is then appropriately cured depending on its composition. For example, if a UV-curable primer is used, then it is exposed to UV radiation for a sufficient time to cure the primer.

A protective film layer 314 is then applied over second primer layer 312 if present or graphic layer(s) 310. Protective film layer 314 can be transparent or clear such that one or more graphic layers 310 are viewable therethrough. Protective film layer 314 can comprise a laminating film, such as a polymeric film made up of one or more virgin and/or recycled polymers, such as, for example, a polypropylene film, polyethylene film. Protective film layer 314 can comprise a thickness of about 0.5 to about 5 mils. In one particular embodiment of the invention, protective film layer 314 comprises a 1-3 mil clear polypropylene laminating film, available from The Treofan Group of Raunheim, Germany or Transilwrap Company, Inc. of Strongsville, Ohio. In another particular embodiment, protective film layer 314 is substantially free from a polyethylene material. In yet another embodiment, all layers of the in-mold label are substantially free from polyethylene.

In one particular embodiment of the invention, the inmold label is used to produce drinking cups or containers. Protective film layer 314 is in direct contact with the liquid or other food material, to be imbibed and/or the user's mouth, tongue or lips. Therefore, protective film layer 314 preferably comprises a food-safe material or coating thereon.

Protective film layer 314 can be bonded to second optimal primer layer 312 if present or graphic layer(s) 310 by an suitable bonding techniques, such as, for example, by adhesive layer 316. Adhesive layer 316 can comprise, for example, any of a number of suitable adhesives including radiation curable adhesives, moisture cure adhesive, urethane adhesive, water-based or other solvent-based adhesive, and combinations thereof. In one particular embodiment, adhesive layer 316 comprises a two-part urethane adhesive such as a polymeric laminating adhesive, available from Polymeric Imaging Inc. of North Kansas City, Mo. Other suitable adhesives are available from Ashland, Inc. of Covington, Ky., HB Fuller Co. of St. Paul, Minn., and Henkel of Dusseldorf, Germany.

Adhesive layer 316 can be applied to one or both of the outermost layer of the printed metalized substrate assembly 301, such as second optional primer layer 312, or protective film layer 314. Adhesive layer 316 can be applied by any of a number of techniques including, but not limited to extruding, casting, printing such as inkjet printing, flexographic printing, rotogravure, curtain coating, spraying, gravure, mire rod coating, and the like. Heat and/or pressure is then applied to combine or bond protective film layer with the printed metalized substrate assembly 301.

Upon sufficient curing of adhesive layer 316, film construction sheet 300 is then converted, such as by die cutting, into the appropriate label size for use in injection molding or blow molding techniques for manufacturing labeled plastic products. For example in injection molding, the in-mold label is placed into the female wall of a mold such that protective film layer 314 is proximate the wall of the mold. The label is held by mechanical means, such as by vacuum or friction. A plastic charge or molten material is then introduced into the mold and bonds to the inner most layer, i.e. base substrate 302 to form the final molded product with integral metalized label, such as a drinking cup. The plastic charge material can comprise any of a variety of plastic materials including, but not limited to, polypropylene, polycarbonate, high density polyethylene, and combinations thereof. Upon cooling, the product is ejected from the mold. One such suitable in-mold labeling technique is described in detail in U.S. Pat. No. 7,153,555 to Raymond et al., which is incorporated herein by reference in its entirety.

In one particular embodiment of the invention, the inmold label is used to produce drinking cups or containers. The plastic charge material, i.e. the molded plastic material, is in direct contact with the liquid or other food material to be imbibed. Therefore, the charge material preferably comprises an FDA approved, or food-safe material for direct food contact. Base substrate 302 can optionally comprise a food-safe material or coating thereon for indirect food contact.

Surface Printed Metalized Label with Coating Composition 2

In a fourth embodiment of the invention, illustrated in FIG. 4, a coating construction sheet 400 for use as a surface printed metalized in mold label (IML) comprises a protective coating layer 412 covering a printed metalized substrate assembly 401. For exemplary purposes only, the construction is in sheet form for converting a plurality of labels therefrom; however, other forms are contemplated. For example, sheet 400 can be its own individual label.

A metalized substrate assembly 403 can generally include a base substrate 402 and a metalized layer 404 laminated over at least a portion of base substrate 402. Base substrate 402 can comprise a polymeric film made up of one or more virgin and/or recycled polymers, such as, for example, a polypropylene film, polyethylene film. Base substrate 402 can be from about 1 to about 20 mils thick, and more particularly from about 5 to about 15 mils thick. Base substrate 402 can be transparent, translucent, or opaque. One or both surfaces can be gloss or matte finish, or combinations thereof. In one particular embodiment, base substrate 402 comprises a polypropylene film such as, for example, a 7-14 mil polypropylene film, such as Trans TR available from Transilwrap Company, Inc. of Strongsville, Ohio, or others such as AET Films 313-125 of New Castle, Del., Innovia Film WPA230, RayoForm IW58 available from Innovia Films, and Yupo XFS80 available from Yupo Synthetic Paper.

A metalized material 404, such as a metalized PET available from Transilwrap Company, Inc. of Strongsville, Ohio, is laminated to at least a portion of base substrate 402 to form metalized substrate assembly 403. Metalized layer 404 can be foil layers available from other manufacturers such as Unifoil of Fairfield, N.J., and Protect-All available from PFFC of Chicago, Ill. Metalized material 404 can be laminated or bonded to base substrate 402 by an adhesive layer 406. Adhesive layer 406 can comprise, for example, any of a number of suitable adhesives including radiation curable adhesives, moisture cure adhesive, urethane adhesive, water-based or other solvent-based adhesive, and combinations thereof. In one particular embodiment, adhesive layer 406 comprises a two-part urethane adhesive such as a polymeric laminating adhesive, available from Polymeric Imaging Inc. of North Kansas City, Mo. Other suitable adhesives are available from Ashland, Inc. of Covington, Ky., HB Fuller Co. of St. Paul, Minn., and Henkel of Dusseldorf, Germany.

Adhesive layer 406 can be applied, either prior to and/or during lamination, to one or both of base substrate 402 and metalized material 404. Adhesive layer 406 can be applied by any of a number of techniques including, but not limited to extruding, casting, printing such as inkjet printing, flexographic printing, rotogravure, curtain coating, spraying, gravure, mire rod coating, and the like. Sufficient heat and/or pressure is applied to bond base substrate layer 402 and metalized material 404, and adhesive layer 406 is allowed to cure over time.

A primer layer 408 is optionally applied to at least a portion of metalized layer 404, for increasing ink adhesion. Suitable primers can include Northwest LPX-3 Primer, available from Northwest Coatings, a part of Ashland, Inc., primers available from INX International Ink Co. of Schaumburg, Ill., and primers available from Henkel of Dusseldorf, Germany. Primer layer 408 can be applied by any of a number of suitable coating techniques including, but not limited to, extruding, casting, printing such as inkjet printing, flexographic printing, rotogravure, curtain coating, spraying, gravure, mire rod coating, and the like. Primer layer 408 is then appropriately cured depending on its composition. For example, if a UV-curable primer is used, then it is exposed to UV radiation for a sufficient time to cure the primer.

One or more graphic layers 410 can be printed on at least a portion of optional primer layer 408 if present or directly on at least a portion of metalized layer 404 using any of a number of suitable printing techniques including, but not limited to, digital printing such as inkjet printing, flexographic printing, lithography, rotogravure, gravure, and the like. Graphic layer(s) 410 can be formed using any of a variety of suitable inks, such as, for example, UV-curable inks, toners, water- or solvent-based inks, solventless inks, other forms of radiation curable inks, and combinations thereof. In one embodiment, graphic layer 410 is formed from UV curable inks, such as SUNCURE inks commercially available from Sun Chemical of Carlstadt, N.J., Flint Inks of St. Paul, Minn., and/or Wikoff Color Corporation of Fort Mill, S.C.

In one particular embodiment, as illustrated in FIG. 4, graphic layer(s) 410 include a first ink layer 410a comprising a white UV-curable ink layer, followed by a second ink layer 410b comprising UV-curable ink four color process (4-CP) separation layer, as described in the first embodiment. First ink layer 410a is sufficiently cured upon exposure to UV radiation before second ink layer 410b is applied, which is then sufficiently cured upon exposure to UV radiation. The opposite construction, i.e. second ink layer 410b can be applied first before first ink layer 410a, can also be contemplated.

A protective coating layer 412 is then applied over graphic layer(s) 410. Protective coating layer 412 can be transparent or clear such that one or more graphic layers 410 are viewable there through. Suitable clear coatings can include UV-curable or other radiation curable coatings, moisture cure coatings, urethane coatings, and combinations thereof. In one particular embodiment, protective coating layer 412 comprises an acrylate ester clear coating, available from Polymeric Imaging Inc. of North Kansas City, Mo. It is a form of clear UV-curable ink. Other suitable coatings are available from INX International Ink Co. of Schaumburg, Ill., and Henkel of Dusseldorf, Germany. In a particular embodiment, protective coating layer 412 is substantially free from a polyethylene material. In yet another embodiment, all layers of the in-mold label are substantially free from polyethylene.

In one particular embodiment of the invention, the inmold label is used to produce drinking cups or containers. Protective coating layer 412 is in direct contact with the liquid or other food material, to be imbibed and/or the user's mouth, tongue or lips. Therefore, protective coating layer 412 preferably comprises a food-safe material or coating thereon.

Protective coating layer 412 can be applied by any of a number of suitable coating techniques including, but not limited to, extruding, casting, printing such as inkjet printing, flexographic printing, rotogravure, curtain coating, spraying, gravure, mire rod coating, and the like. Protective coating layer 412 is then appropriately cured depending on its composition. For example, if a UV-curable primer is used, then it is exposed to UV radiation for a sufficient time to cure the primer.

Upon sufficient curing of protective coating layer 412, coating construction sheet 400 is then converted, such as by die cutting, into the appropriate label size for use in injection molding or blow molding techniques for manufacturing labeled plastic products. For example in injection molding, the in-mold label is placed into the female wall of a mold such that protective coating layer 412 is proximate the wall of the mold. The label is held by mechanical means, such as by vacuum, or friction. A plastic charge or molten material is then introduced into the mold and bonds to the inner most layer, i.e. base substrate 402 to form the final molded product with integral metalized label, such as a drinking cup. The plastic charge material can comprise any of a variety of plastic materials including, but not limited to, polypropylene, polycarbonate, high density polyethylene, and combinations thereof. Upon cooling, the product is ejected from the mold. One such suitable in-mold labeling technique is described in detail in U.S. Pat. No. 7,153,555 to Raymond et al., which is incorporated herein by reference in its entirety.

In one particular embodiment of the invention, the inmold label is used to produce drinking cups or containers. The plastic charge material, i.e. the molded plastic material, is in direct contact with the liquid or other food material to be imbibed. Therefore, the charge material preferably comprises an FDA approved, or food-safe material for direct food contact. Base substrate 402 can optionally comprise a food-safe material or coating thereon for indirect food contact.

The resulting container or cup with integral label provides sufficient structural integrity such that it is dish-washer safe, and can be used multiple times without delamination. The surface printed metalized in mold label can be efficiently and economically produced, while offering eye-catching features on the surface of the article or container.

The invention may be embodied in other specific forms without departing from the essential attributes thereof; therefore, the illustrated embodiments should be considered in all respects as illustrative and not restrictive. For example, the process or method of forming metalized substrate assembly 403 described in the fourth embodiment referring to FIG. 4 can be alternatively be used to form metalized substrate assembly 103 of the first embodiment of FIG. 1 or metalized substrate assembly 303 of the third embodiment of FIG. 3.

What is claimed is:

1. A metalized in-mold label for producing a molded plastic object using a plastic molding assembly, the in-mold label comprising:
a metalized film assembly including—
a substrate presenting a first surface and a second surface, and
a metalized layer bonded to at least a portion of the first surface of the substrate;
a protective layer; and
one or more printed image layers sandwiched between the metalized film assembly and the protective layer, wherein the one or more printed image layers are viewable through the protective layer,
wherein the protective layer is adapted to reduce or prevent electric arcing between the in-mold label and a mold cavity of the plastic molding assembly.

2. The metalized in-mold label of claim 1, wherein the protective layer comprises a polymeric layer, and one or more printed image layers are printed on at least a portion of an interior surface of the polymeric layer.

3. The metalized in-mold label of claim 2, wherein the protective layer is laminated to the metalized film assembly using an adhesive applied to at least one of protective layer and the metalized film assembly.

4. The metalized in-mold label of claim 1, wherein the one or more printed image layers are printed on at least a portion of the first surface of the substrate having the metalized layer thereon.

5. The metalized in-mold label of claim 1, wherein the metalized film assembly further comprises an e-beam curable adhesive over at least a portion of the first surface, and wherein the e-beam curable adhesive bonds the metalized layer to the first surface.

6. The metalized in-mold label of claim 4, wherein the protective layer comprises a transparent coating comprising a radiation curable coating, moisture cure coating, urethane coating, or combinations thereof.

7. The metalized in-mold label of claim 1, wherein the protective layer comprises a protective film bonded to the metalized film assembly thereby sandwiching the one or more printed image layers in between, and wherein the protective film is bonded using one or more adhesives comprising a radiation curable adhesive, moisture cure adhesive, urethane adhesive, water-based adhesive, or combinations thereof.

8. The metalized in-mold label of claim 1, wherein the one or more printed image layers comprise a first printed image layer comprising a four color process separation layer, and a second printed image layer comprising a white spot printed ink layer.

9. The metalized in-mold label of claim 1, wherein the molded plastic object comprises a cup, and the in-mold label is integral with the cup defining at least a portion of a sidewall of the cup.

10. A method of producing a metalized in-mold label for producing a molded plastic object using a plastic molding assembly, the method comprising:
providing a substrate having a first surface and a second surface;
applying a metalized layer to at least a portion of the first surface of the substrate to form a metalized film assembly having a metalized surface and an opposing non-metalized surface;
providing a protective layer, wherein the protective coating assembly is adapted to reduce or prevent electric arcing between the in-mold label and a mold cavity of the plastic molding assembly;
printing one or more printed image layers on at least a portion of the metalized surface, the protective layer or both; and
sandwiching the one or more printed image layers between the metalized film assembly and the protective layer to form an imaged metalized assembly;
wherein the one or more printed image layers are viewable through the protective layer.

11. The method of claim 10, wherein applying a metalized layer to at least a portion of the first surface of the substrate comprises:
applying a transfer adhesive to at least a portion of the first surface of the substrate;
providing a metal-containing material;
applying the metal-containing material to the transfer adhesive; and
curing the transfer adhesive to bond the metal-containing layer thereto.

12. The method of claim 11, wherein providing a metal-containing material comprises:
providing a carrier film having a breakaway adhesive thereon; and
depositing the metal-containing material thereon,
wherein upon curing of the transfer adhesive, the carrier film breaks away from and is removed from the metal-containing material, leaving the metal-containing material bonded to the transfer adhesive.

13. The method of claim 11, wherein transfer adhesive comprises an e-beam curable adhesive, and wherein curing of the transfer adhesive comprises exposure of the transfer adhesive to an e-beam source.

14. The method of claim 10, wherein the protective layer comprises a polymeric layer, and one or more printed image layers are printed on at least a portion of the polymeric layer.

15. The method of claim 14, wherein the protective layer is laminated to the metalized film assembly using an adhesive applied to at least one of protective layer and the metalized film assembly.

16. The method of claim 10, wherein the one or more printed image layers are printed on at least a portion metalized layer of the metalized film assembly.

17. The method of claim 17, wherein the protective layer comprises a transparent coating comprising a radiation curable coating, moisture cure coating, urethane coating, or combinations thereof.

18. The method of claim 10, wherein the protective layer comprises a protective film bonded to the metalized film assembly thereby sandwiching the one or more printed image layers in between, and wherein the protective film is bonded using one or more adhesives comprising a radiation curable adhesive, moisture cure adhesive, urethane adhesive, water-based adhesive, or combinations thereof.

19. The method of claim 10, wherein the one or more printed image layers comprise a first printed image layer comprising a four color process separation layer, and a second printed image layer comprising a white spot printed ink layer.

20. The method of claim 10, further comprising:
cutting a metalized in-mold label from the imaged metalized assembly;
positioning the metalized in-mold label in the mold cavity of the plastic molding assembly such that the protective layer is positioned proximate a mold wall of the mold cavity;
operating the plastic molding assembly to process a plastic material charge into the mold cavity to form the plastic object; and
cooling and ejecting the plastic object from the mold cavity,
wherein no arcing is produced between the mold wall and the protective layer.
